(19) United States
(12) Patent Application Publication
(10) Pub. No.: US 2022/0331624 A1
(43) Pub. Date: Oct. 20, 2022

(54) FACIAL PROTECTION ELEMENT FOR PROTECTION AGAINST RISKS OF EXPOSURE TO INFECTIOUS BIOLOGICAL AGENTS

(71) Applicant: FUNDACION UNIVERSIDAD CATOLICA DE VALENCIA SAN VICENTE MARTIR, Valencia (ES)

(72) Inventors: Ángel SERRANO AROCA, Valencia (ES); Miguel MARTI JIMENEZ, Valencia (ES)

(73) Assignee: FUNDACION UNIVERSIDAD CATOLICA DE VALENCIA SAN VICENTE MARTIR, Valencia (ES)

(21) Appl. No.: 17/721,437

(22) Filed: Apr. 15, 2022

(30) Foreign Application Priority Data
Apr. 15, 2021 (ES) U202130782

(51) Int. Cl. A62B 23/02; A41D 13/11

(52) U.S. Cl. CPC A62B 23/025; A41D 13/1184; A41D 13/1161; A41D 13/1192

(57) ABSTRACT

The present invention describes a facial protection element for protection against risks of exposure to infectious biological agents, such as microorganisms, like a virus with an envelope, including SARS-CoV-2 and the multidrug-resistant Gram-positive bacteria. Specifically, the present invention relates to a facial protection element of the type comprising: face shields, glasses, masks, counter shields, etc., which prevent not only direct exposure to the infectious biological agent, but rather also inactivate same once the biological agent comes into contact with the facial protection element. The facial protection element comprises a plastic material or glass with a biocidal agent coating layer.

### TECHNICAL FIELD

The present invention is comprised among facial protection elements for protection against risks of exposure to infectious biological agents, such as microorganisms, in particular those of the type comprising viruses with an envelope, including SARS-CoV-2 and multidrug-resistant Gram-positive bacteria. Specifically, the present invention relates to a facial protection element configured as face shields, glasses, helmets, masks, space partitioning shields of the type for a counter or a vehicle, etc., preventing direct contact between the person and the biological agent, such as a microorganism, such that it avoids inhalation and entry thereof into the body through the airways or by splashes (in a surgical procedure, for example), with the desired effect being produced through the inactivation of the infectious microorganism once it comes into contact with the protection element.

### STATE OF THE ART

The rapid propagation of the COVID-19 pandemic caused by the pathogen SARS-CoV-2, which was detected in Wuhan, Hubei province, China, in December 2019 _{[1]} has had devastating global consequences in terms of health and economic recession. According to the WHO, the current outbreak of COVID-19 has millions of confirmed cases and millions of deaths in more than 200 countries _{[2]}. The present zoonotic coronavirus is similar to the SARS coronavirus (˜79% similarity) and MERS coronavirus (˜50% similarity) _{[3-6]} and is more closely related (88-89% similarity) to two bat-derived coronaviruses, bat-SL-CoVZC45 and bat-SL-CoVZXC21 _{[7]}. The SARS-CoV-2 pathogen is stable for up to three hours in aerosols and up to four hours, 24 hours, and 2-3 days on copper, cardboard, plastic, or stainless steel surfaces, respectively _{[8]}, which demonstrates that infections can be readily air-borne _{[9]} through microdroplets or through direct contact after touching contaminated surfaces. In fact, it can propagate more rapidly than its two predecessors, SARS-CoV and MERS-CoV _{[10]}, through coughing, sneezing, touch, or breathing _{[11]}, and more readily through asymptomatic carriers _{[12,13]}.

In addition to the foregoing, there are a number of other infectious biological agents which propagate through the air and represent an important risk for human health. Included among them are fungi, bacteria, and other viruses. Except for rare exceptions, the etiological agents of respiratory infections are viruses. The viruses most often involved are rhinovirus, coronavirus, parainfluenza, and adenovirus, and those least frequently involved are respiratory syncytial virus (RSV) and enterovirus. Depending on the series studied, the proportions of each virus vary, but rhinoviruses are generally the most common agents. Due to diagnostic difficulties, the frequency of Coronavirus is probably underestimated, but it is known to play an important role in the etiology of the common cold. As for Adenoviruses, some types (1, 2, 5, 6) are associated with non-specific symptoms like the common cold, whereas others tend to cause more specific symptoms (e.g. 3 and 7—fever pharyngoconjunctival; 8—keratoconjunctivitis). The influenza virus affects the nasal mucous membrane over the course of infections which simultaneously affect other areas of the respiratory tract, even the lower tract.

Another important risk is brought about by respiratory infections caused by bacteria. Streptococcus pneumoniae is the bacterium targeted by respiratory infections, being the organism that is isolated most often and with the highest mortality. It is the cause of many respiratory processes: pneumonia, otitis, sinusitis, complicated with sepsis, meningitis and abscesses.

Pulmonary diseases produced by the action of the fungi are basically due to two mechanisms: the infectious mechanism and the immunoallergic mechanism. Pulmonary mycotic infections are a pathology of extreme interest both due to their increased frequency and due to the problems raised by the diagnosis and treatment thereof. Pulmonary mycoses (PM) are systemic infections affecting both the lung parenchyma and the bronchi, and in some cases they may be a starting point for remote disseminations. The etiological agents of these processes vary greatly, but their virulence and epidemiological conditioning factors can be classified in primary pathogenic fungi and opportunistic fungi, such as: Candida albicans, Candida sp, Histoplasma capsulatum, Paracoccidioides brasiliensis, Blastomyces dermatitidis, Coccidioides immitis, Sporothrix schenckii, Aspergillus fumigatus, etc.

Besides the therapeutic treatments intended for combating these diseases and in those cases in which there are no effective therapies for the treatment of infections caused, facial protection equipment has become extremely important.

The facial protection equipment for protection against infectious biological agents includes that equipment with ocular and/or respiratory protection (nose and mouth) and are intended for reducing the entry of biological microorganisms, splashes, and aerosols through the airways or mucous membranes. The choice of one type of specific protection resides in the choice of the equipment according to the protection against particles, given that biological agents, such as microorganisms which may enter through the airways, are those associated with droplets of biological fluids or particles (in general, biological aerosols).

The professionals responsible for choosing the suitable protection equipment often ask themselves if the protection filters for protection against particles are truly effective against biological agents, this is because of the very small size of these infectious particles. A good example of this is protection equipment based on woven or non-woven fabrics incorporating filtration materials. In general terms, the efficacy of these filtration materials is based on a combination of different filtration mechanisms. The final result is that these filters are partially or completely effective against particles according to the size thereof based on the fact that these biological agents may or may not be retained in the meshes forming filtration materials.

There are different types of respiratory protection equipment and protection equipment for protection against infectious splashes, self-filtering masks, facepieces with filters, motorized equipment, etc. The choice between these will depend on the efficacy needed, but also on other criteria such as the user's features, work post features, etc.

Furthermore, given that a lower limit below which the biological agent is not harmful cannot be established, there will be a tendency to always choose the maximum level of protection available, always considering the real danger and risk of contracting the disease.

Among the most widely used respiratory protection equipment and protection equipment for protection against infectious splashes, there are different versions of masks, molded or folded, with or without an exhalation valve, to be adapted to different situations, or even personal preferences.

Self-filtering masks are usually single-use masks and can be disposed of after several hours or sooner if they contain any splash. While they are disposable, they simplify equipment decontamination procedures, but they result in highly harmful effects in terms of environmental waste management.

Another option would be the protection equipment more commonly referred to as face shields made from plastic materials. This protection equipment acts by forming a barrier between the user of the shield and the biological agent, thereby preventing in the best-case scenario the entry of the agent through the airways and mucous membranes. While the effectiveness thereof when combined with other measures of protection is not questioned, by itself protection of this type is not entirely effective in that many infectious biological agents are able to survive on the surface for a prolonged time. This fact does not allow ruling out contamination of the user through inhalation of these agents while handling the shield when use thereof has ended, for example.

Spanish patent ES2121640B1 describes disposable eye protection glasses of the type of forming a body with four sides which is anatomically fitted to the face, covering both eyes and excluding the nasal vestibule, and serving as a mount for a shield made of a transparent material which allows seeing through same. They are characterized by being built from flexible poster board or cardboard, with a slightly padded rim made of cellulose, rubber, foam, or a similar material, on the edge which is anatomically fitted to the face. A shield made of a thin transparent rigid or semi-rigid material is hermetically fixed to this body on the opposite edge.

Spanish patent ES2294191T3 describes a filtering system consisting of: A) a protective face mask; B) a filter against biological agents; C) a connector useful for attaching the filter to the mask in an easy, quick, and effective manner, characterized in that the face mask A) is a commonly known protective face mask, filter B) consists of a pleated membrane made of ceramic microfibers placed inside a transparent plastic container, having a controlled seal and blunt angles, said membrane being hydrophobic on the worker side, preventing the penetration of liquid with a surface tension >70 dynes/cm, and hydrophilic on the environment side for the purpose of assuring good humidification performance; the connector C) consists of a single-piece cylinder that has, on the mask side, an outer diameter equal to 40 mm and the appropriate threading to screw it onto the mask and, on the filter side, an outer diameter equal to 35.5 mm and an internal diameter equal to 25.6 (+0.2/−0.0 mm), in which an O-ring with a locking and sealing function is inserted.

Spanish patent ES2393983T3 describes a facial protection system for protection against biological agents, comprising a substantially rigid and relatively lightweight equipment support structure for the head. As is conventional, a ventilator mechanism is assembled in the structure to circulate air. It further includes one or more removable and disposable filters adapted for being attached to the structure, a transparent face shield or lens for covering the face and maintaining sterile conditions, a flexible containing cover adapted for facial attachment at the lower edge of the shield for purposes of surrounding the lower protrusion of the lens and forming a sealed off space around the user's head, and lastly, an adjustable head strap.

There are several technical problems associated with the facial protection systems and devices described in the state of the art, including: On one hand, the described systems may require complicated and expensive construction and assembly processes due to the large number of different components of said systems; second, said devices may not be comfortable for the user due to the complexity thereof; third, while all devices carry out the function of acting as a barrier against direct exposure to the infectious biological agent, they may not be altogether effective, since the device does not carry out the function of inactivating said infectious agents to prevent contamination while handling same after use, and lastly, with respect to the environmental risk associated with the recycling thereof, the waste management stemming from these systems presents problems with the management due to the nature of the different parts forming same, as well as the environmental risk caused by the recycling thereof. In many cases, these devices are for a single use and/or do not allow easy disinfection.

The present invention proposes a solution to the problems technical identified above by providing facial protection elements for protection against risks of exposure to infectious biological agents, such as microorganisms, comprising a structure made from transparent plastic material or glass, comprising a coating containing an antimicrobial composition. Therefore, not only do the protection elements of the present invention act as a barrier against direct exposure to infectious biological agents, but they also inactivate said agents. The protection elements are easy to obtain, handle, and decontaminate, so they can be used repeatedly without losing their antimicrobial functionality, with the subsequent advantage of environmental management savings in managing the waste they generate.

### DISCLOSURE OF THE INVENTION

The present invention relates to a facial protection element for protection against risks of exposure to infectious biological agents, such as microorganisms. Specifically, the present invention relates to a facial protection element of the type comprising: face shields, glasses, helmets, masks, space partitioning shields, such as for example those partitioning shields for counters or vehicles, etc., which prevent not only direct exposure to the infectious biological agent, but rather also inactivate same once the biological agent comes into contact with the facial protection element. Said infectious agent could come into contact with the facial protection element through fluids such as aerosols and/or splashes containing said fluids.

The facial protection element comprises a body with at least one transparent and impermeable surface made of plastic material or glass, characterized in that said surface comprises a coating of a biocidal agent.

The facial protection element has a body with different shapes and sizes. The facial protection element of the invention is presented in the form of face shields, helmets, glasses, masks, space partitioning shields, for example, for counters or vehicles, etc.

These elements are intended for covering and/or preventing direct exposure between the user and the infectious biological agent, among others, they act as a barrier between the infectious biological agent and the eyes and/or airways of the user, for example, nose and mouth, thereby preventing the biological agent from coming into direct contact with the user.

The protection element comprises a body with at least one surface made of plastic material or glass. The plastic material is in particular a transparent or non-transparent thermoplastic material which can be made from synthetic or natural and/or biodegradable plastic materials as well as mixtures thereof. The surface made of plastic material can contain one or more layers of plastic material. Among synthetic thermoplastic materials, the following thermoplastic polymers can be mentioned: polyethylene terephthalate (PET), polyvinyl chloride (PVC), polypropylene (PP), high or low density polyethylene (PE), polycarbonate (PC), polymethyl-methacrylate (PMMA), polystyrene (PS), polyhydroxyethyl acrylate (PHEA), polyhydroxyethyl methacrylate (PHEMA), polyamide or nylon (PA), polybutylene (PB) and Teflon (or polytetrafluoroethylene, PTFE), polypyrrole (PPy), polyaniline, polythiophene, poly(3,4-ethylenedioxythiophene, poly(3,4-ethylenedioxythiophene, poly(3,4-ethylenedioxythiophene)-poly(styrene sulfonate), polythiophene-vinylidene), poly(2,5-thiethylene-vinylidene), poly(3-alkylthiophene, poly(p-phenylene), poly-p-phenylene-sulfide, poly(p-phenylenevinylene), poly(p-phenylene-terephthalamide), poly(3-octylthiophene-3-methylthiophene), and poly(p-phenylene-terephthalamide), poly(vinyl alcohol) (PVA), as well as mixtures thereof.

As an example of the biodegradable natural materials, the following can be considered: chitosan, hyaluronic acid, carrageenan, starch, acacia gum, xanthan gum, pectins, proteins, chitin, pullulan, non-crosslinked alginate, calcium alginate, zinc alginate, strontium alginate and other alginate hydrogels crosslinked with other divalent cations, poly(3-hydroxybutyrate-co-3-hydroxyvalerate) (PHBV), poly(3-hydroxypropionate), poly(3-hydroxybutyrate), poly(3-hydroxyvalerate), poly(3-hydroxyhexanoate), poly(3-hydroxyoctanoate), poly(3-hydroxyoctadecanoate), poly(4-hydroxybutyrate), poly(4-hydroxyvalerate), poly(5-hydroxyvalerate) gelatin, and/or collagen, as well as mixtures thereof.

For the purpose of solving the technical problem considered in the present invention, the protection element comprises at least one surface, where said surface comprises one or more layers of plastic material or glass characterized by further comprising a coating layer with biocidal functionality arranged on at least one of the inner or outer faces of the surface made of plastic material or glass. For purposes of the invention, the inner face of the surface made of plastic material or glass is the face close to the eyes, nose, and mouth of the user, whereas the outer face is the face opposite the inner face of the surface made of plastic material or glass.

The coating layer with biocidal functionality, that is, the biocidal agent coating layer, comprises at least one compound with antimicrobial activity selected from the group comprising triclosan, citric acid, acetic acid, sodium 2-biphenylate, sodium hypochlorite, salicylic acid, alkyldimethyl benzyl ammonium chloride, hydrogen peroxide, sodium dichloroisocyanurate, didecyldimethylammonium chloride, C12-16 alkyldimethyl benzyl ammonium chloride, sodium dichloroisocyanurate, sodium dichloroisocyanurate dihydrate, propan-1-ol, glutaraldehyde, peracetic acid, isopropyl alcohol, ethanol, benzyl-C12-C16-alkyldimethyl ammonium chloride, pentapotassium bis(peroxymonosulfate) bis(sulfate), C12-18 saccharinate, orthophenylphenol, orthophenylphenol, chlorine dioxide, pentapotassium bis(peroxymonosulfate) bis(sulfate), didecyldimethylammonium chloride, N-dichlorofluoromethylthio-N′,N′-dimethyl-N-phenyl-sulfamide (dichlofluanid), pyridine-2-thiol-1-oxide, sodium salt (sodium pyrithione), sulfur dioxide, sodium bromide, ammonium sulfate, silver, silver chloride, ammonium bromide, potassium 2-biphenylate, bromine chloride, sodium p-Chloro-m-cresolate, mixture of cis- and trans-p-menthane-3,8-diol (citriodiol), tetrakis(hydroxymethyl)phosphonium sulfate (1:2) (THPS), didecyldimethylammonium chloride (DDAC (Cao)), 6-(phthalimido)peroxyhexanoic acid (PAP), tetrachlorodecaoxide complex (TCDO), active chlorine: obtained by the reaction of hypochlorous acid and sodium hypochlorite produced in situ, silver and zinc zeolite, silver and copper zeolite, esfenvalerate/(S)-α-cyano(3-phenoxybenzyl) (S)-2-(4-chlorophenyl)-3-methylbutyrate (esfenvalerate), boric acid, borax, copper nanoparticles, gold, silver, graphene, graphene oxide, fullerene, carbon dots, graphite, reduced graphene oxide, reduced graphene, simple or multi-walled carbon nanotubes, carbon nanofibers, fullerene, alkylamine- or ammonia-functionalized graphene oxide, boron doped graphene, nitrogen doped graphene, phosphorus doped graphene, sulfur doped graphene, boron and nitrogen doped graphene, phosphorus and nitrogen doped graphene, sulfur and nitrogen doped graphene and sulfonated reduced graphene oxide, graphene/TiO₂, graphene/Fe₃O₄, graphene/Mn₃O₄, graphene/Pd, graphene/Pt, graphene/PtCo, graphene/PtPd, reduced graphene/TiO₂, reduced graphene/Fe₃O₄, reduced graphene/Mn₃O₄, reduced graphene/Pd, reduced graphene/Pt, reduced graphene/PtCo and reduced graphene/PtPd, geraniol, thymol, citrodiol, sanicitrex, condensed tannins, procyanidin or proanthocyanidins A, B, C and D (A1, A2, A3, A4, B1, B2, B3, C1, C2, C3, D1, D2, D3, etc.), grapeseed extract, cranberry, blueberry, and blackberry extract, cocoa extract, flavanols, flavonoids, afzelechin, cinnamon extract, green and black tea extract, catechin, epicatechin gallate, epigallocatechin, epigallocatechin gallate, proanthocyanidins, theaflavins, thearubigins, polyphenols, citronella and preferably, compounds of quaternary ammonium and derivatives thereof, such as: benzethonium chloride, methylbenzethonium chloride, cetalkonium chloride, cetylpyridinium chloride, cetrimonium, cetrimide, tetraethylammonium bromide, didecyldimethylammonium chloride, domiphen bromide and benzalkonium chloride. In a particular embodiment of the present invention, the biocidal agent is benzalkonium chloride.

The coating layer arranged on the outer and/or inner surface of the plastic material or glass has a thickness of 0.001 to 100 μm, preferably, 25 μm. Another feature of the coating layer is that it has a degree of complete transparency, and once it is applied on the surface made of plastic material or glass, it maintains the same degree of transparency of the facial protection element.

The embodiment of the facial protection element comprises, on one hand, obtaining the facial protection element having the desired shape and size from the plastic material or glass, and arranging the biocidal solution coating on the outer and/or inner plastic or glass surface of the facial protection element. The first part of the process, i.e., obtaining the specific facial protection element (face shield, helmet, glasses, mask, partitioning shield) made of plastic material or glass is performed through molding techniques already known in the state of the art, such as injection molding. At present, these facial protection elements are also commercially available.

The second part of the process comprises arranging the biocidal agent coating on the outer and/or inner layer of the facial protection element. Said step of the method can be performed by applying a solution containing the biocidal agent by means of spraying the biocidal agent solution on the surface of the facial protection element. Another technique used for these purposes of the dip-coating technique, which consists of immersing the facial protection element made of plastic material or glass in the biocidal agent solution at a temperature between 1 and 80° C., preferably 25° C., for a period between 1 second and 8 hours, preferably 30 minutes. Next, the facial protection element with the biocidal solution coating is dried at room temperature, air-dried and/or dried in a drying oven at a temperature lower than the degradation temperature of the plastic, not more than 40° C.

The biocidal agent solution used for purposes of the present invention comprises, together with the biocidal agent, a solvent selected from: chloroform, trifluoroethanol, dichloromethane, hexafluoro-2-propanol, acetone, ethanol, methanol, propylene carbonate, dimethylsulfoxide, methylene chloride, toluene, N, N-dimethylformamide, dioxane, 1-methyl-2-pyrrolidone, a mixture of water and alcohol in any composition, dimethylsulfoxide, ethylene-hexylene glycol, ethylene glycol, saline, and/or water.

Preferably, the biocidal agent solution comprises benzalkonium chloride and ethanol. The amount of biocidal agent in the solution is between 0.00001 and 50% by weight, more preferably 0.1% by weight, and the concentration of solvent in the solution is between 50 and 99.99999% by weight, more preferably 99.9% by weight. A particular case of the present invention uses a biocidal agent solution comprising 0.1% by weight of benzalkonium chloride and 99.9 by weight of solvent made up of 70° ethyl ethanol (mixed with 70% by volume of absolute ethanol and 30% by volume of distilled water).

The facial protection elements according to the present invention prove to be particularly effective against infectious biological agents selected from: human coronavirus (HCoV), hepatitis B virus (HVB), hepatitis C virus (HCV), hepatitis D virus (HDV), dengue virus (DENV), Japanese encephalitis virus (JEV), yellow fever virus, Western Nile virus (WNV), Venezuelan equine encephalitis virus (VEEV), Eastern equine encephalitis virus (EEEV), Western equine encephalitis virus (WEEV), tick-borne encephalitis virus (TBEV), Rift Valley fever virus (RVFV), herpes simplex virus type 1, herpes simplex virus type 2, human herpesvirus 6 (HHV-6), human herpesvirus 7 (HHV-7), human T-lymphotropic virus (HTLV), Epstein Barr virus (EBV), human cytomegalovirus (HCMV), Lassa virus (LASV), lymphocytic choriomeningitis virus (LCMV), Nipah virus, influenza A virus, influenza B virus, influenza C virus, Hantaan virus (HTNV), Junin virus, rabies virus, Ebola virus, Marburg virus (MARV), Zika virus (ZIKV), severe acute respiratory syndrome coronavirus (SARS-CoV), severe acute respiratory syndrome coronavirus type 2 (SARS-CoV-2), Middle East respiratory syndrome coronavirus (MERS-CoV), human coronavirus 229E (HCoV-229E), human coronavirus OC43 (HCoV-OC43), human coronavirus NL63 (HCoV-NL63), human coronavirus HKU1 (HCoV-HKU1), human immunodeficiency virus (HIV), varicella-zoster virus (VZV), measles virus, mumps virus (MuV), human respiratory syncytial virus (RSV), rubella virus (RuV), as well as multidrug-resistant Gram-positive bacteria, such as Streptococcus pneumoniae, Staphylococcus aureus, Staphylococcus epidermidis, Streptococcus pyogenes, Streptococcus agalactiae, Bacillus anthracis, Enterococcus faecalis, and Enterococcus faecium. As shown in the particular embodiment of the invention, the biocidal effect comprises 100% inactivation of the biological agent after exposure thereof on the surface made of plastic material with coating according to the invention for at least 1 minute.

### BRIEF DESCRIPTION OF FIGURES

FIG. 1 depicts a facial protection shield made of plastic material.

FIG. 2 depicts AFM topography images (height), amplitude error (E Amp), 2D phase images, and a 3D phase representation, recorded in tapping mode, of the untreated plastic (U Plastic), plastic treated by means of dip-coating with the ethanol-based solvent (S Plastic), and filter with the benzalkonium chloride (BAK) biofunctional coating (BAK Plastic) by scanning a 10 μm×10 μm area.

FIG. 3 illustrates the morphology of the BAK biofunctional coating on the PET plastic by means of field-emission scanning electron microscopy with EDS for elemental analysis. PET plastic with 0.182±0.034% w/w of BAK biofunctional coating (BAK Plastic) at two magnifications: (a) ×150 and (b) ×720, and (c) EDS for elemental analysis of the coating and the PET matrix.

FIG. 4 depicts the opacity results of the untreated plastic (U Plastic), plastic treated by means of dip-coating with the ethanol-based solvent (S Plastic), and filter with the BAK biofunctional coating (BAK Plastic). The results of the ANOVA statistical analysis are indicated in this graph; ns: not significant.

FIG. 5 depicts the antibacterial disk diffusion tests in agar. Untreated plastic (U Plastic), plastic treated by means of dip-coating with the ethanol-based solvent (S Plastic), and plastic treated with the BAK biofunctional coating (BAK Plastic) after 24 hours of culture at 37° C. The normalized distances of the antibacterial halos, expressed as the mean±standard deviation and calculated with equation (1), are shown in each image.

FIG. 6 depicts the loss of viability of phage phi6 measured by the double-layer method. Phage 6 titration images of undiluted samples for control, untreated plastic (U Plastic), plastic treated with a filter by means of dip-coating with the ethanol-based solvent (S Plastic), and plastic with BAK biofunctional coating (BAK Plastic) at 1 min of viral contact.

FIG. 7 depicts the reduction of the infectious titers in PFU/mL determined by the double-layer assay for phage phi6. Logarithm of plaque forming units per mL (log (PFU/mL)) of the control, untreated plastic (U Plastic), plastic treated with a filter by means of dip-coating with the ethanol-based solvent (S Plastic), and disk with the BAK biofunctional coating (BAK Plastic) at 1 minute of viral contact.

FIG. 8 depicts the reduction of infectious titers in PFU/mL of SARS-CoV-2 after 1 min of contact determined by the TCID50/mL method. Untreated plastic (U plastic), plastic treated with the ethanol solvent (S Plastic), disk with the BAK biofunctional coating (BAK Plastic). The set of experimentally measured points are depicted by means of dots, squares, and triangles.

### DETAILED DISCLOSURE OF AN EMBODIMENT OF THE INVENTION

1. Materials and Methods

1. 1. Dip-Coating with Benzalkonium Chloride Solution

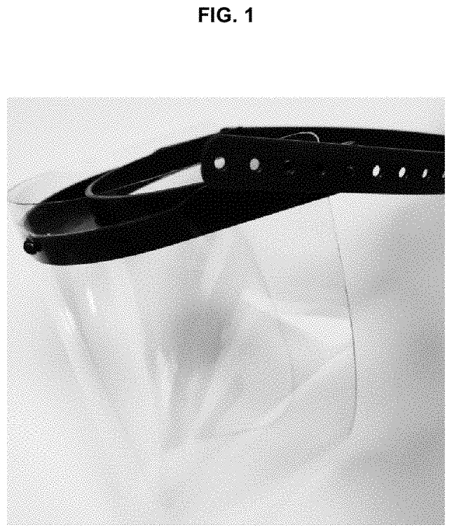

The facial protection element in the form of treated protective shield treated as follows was acquired from Plsticos Villamarchante S.L (http://plasticosvillamarchante.com/. The transparent plastic forming the protection shield is made of polyethylene terephthalate (PET). The front black piece and the rear black strap are made of polypropylene (PP) (FIG. 1). The transparent PET plastic has a thickness of 0.3167±0.0408 mm. The coating with benzalkonium chloride (BAK) was performed by means of the dip-coating method to achieve a BAK content of 0.182±0.034% w/w on the surface of the PET (mass percentage that remains of BAK on the final PET plastic after arranging the BAK coating).

Six replicates (n=6) of each type of sample were tested by cutting PET disks from the protective shield measuring about 10 mm in diameter with a cylindrical punch. Six replicates of untreated plastic measuring 10 mm in diameter were also cut in order to be used as reference material. The disks were treated as described by introducing 6 disks in a beaker that contained 100 ml of solution for 30 minutes at 25°, and then they were dried at 60° for 48 hours. The disks were provided treatment with UV radiation one hour per side after the drying as a method of sterilizing the disks.

### 1.2. Atomic Force Microscopy (AFM)

Atomic force microscopy (AFM) was performed with a Bruker MultiMode 8 SPM, operating in tapping mode in air and with the NanoScope V controller and NanoScope 8.15 software. A cantilever of antimony doped silicon (n) by Bruker with a scanning speed of 0.500 Hz was used. The phase signal was set to zero at the resonant frequency of the tip. The tapping frequency was 5%-10% less than the resonant frequency. The amplitude of the unit and the amplitude set point were 308.5 and 644.8 mV, respectively, and the aspect ratio was 1.00.

In the atomic force microscope (AFM), a sharp tip located at the end of a flexible cantilever runs over the surface of a sample, keeping a small interaction force constant. The scanning movement is performed by a piezoelectric scanner, and tip/sample interaction is monitored, reflecting a laser off the rear part cantilever, which is picked up in a photodiode detector. The photodiode is split into 4 segments, and the voltage differences between the different segments (generally the top 2 with respect to the bottom 2) precisely determine the changes in inclination or oscillation amplitude of the tip.

Tapping AFM: Measures the topography by intermittently touching the surface of the sample with an oscillating tip. Lateral and pressure forces which may damage soft samples and reduce image resolution are eliminated. It can be performed in the air and in liquid medium.

Phase image: Provides images in which the contrast is caused by differences in the adhesion and viscoelasticity properties of the surface of the sample. It is performed in tapping mode and measured as the delay in the oscillation phase of the tip measured in the photodiode, with respect to the value of oscillation phase provided by the piezo of the support for the tip.

### 1.3. Electron Microscope

A Zeiss Ultra 55 field-emission scanning electron microscope (FESEM, Zeiss Ultra 55 model) was operated at an acceleration voltage of 10 kV to observe the morphology of the BAK biofunctional coating on the treated PET surface at two magnifications (×150 and ×720). The plastic samples were prepared to be conductive by means of coating with platinum using a cathode sputtering coating unit. This electron microscope is equipped with energy-dispersive X-ray spectroscopy (EDS) to estimate the elemental ratio at 2.00 kV.

### 1.4. Transparency

The transparency or opacity of the treated and untreated samples was evaluated according to the spectrophotometric method used by Park and Zhao [S. II Park, Y. Zhao, Incorporation of a high concentration of mineral or vitamin into chitosan-based films, J. Agric. Food Chem. 52 (2004) 1933-1939. doi: 10.1021/jf034612p]. Therefore, the rectangular samples (4 mm×50 mm) of the treated and untreated samples were placed directly in a spectrophotometer cell to measure absorbance at 600 nm with a UV/VIS Nanocolor UV0245 spectrophotometer (Macherey-Nagel, Germany). The treated and untreated samples were dried at 60° C. for 24 hours before each measurement, and an empty cell was used as a reference. After that, the opacity (O) of the films can be determined using equation (1), where Abs600 is the value of absorbance at 600 nm and x is the thickness of the sample in mm.

O=Abs600/x (1)

The measurements were taken with three samples of each material to ensure the reproducibility of the measurements and were calculated as absorbance divided by the thickness of the film (expressed in mean±standard deviation).

### 1.5. Bacterial Culture for Phage Phi6

Was cultured Pseudomonas syringae(DSM 21482) from the Leibniz Institute DSMZ-German Collection of Microorganisms and Cell Cultures GmbH (Braunschweig, Germany) in solid tryptic soy agar (TSA, Liofilchem) and then in liquid tryptic soy broth (TSB, Liofilchem). Incubation of the liquid was carried out at 25° C. and 120 rpm.

### 1.6. Propagation of Phage Phi6

The propagation of phage phi6 (DSM 21518) was carried out according to the specifications provided by the Leibniz Institute DSMZ—German Collection of Microorganisms and Cell Cultures GmbH (Braunschweig, Germany).

### 1.7. Antiviral Test Using the Biosafe Viral Model

A 50 μL volume of a phage suspension in TSB was added to each filter at a titer of about 1×10⁶ plaque forming units per mL (PFU/mL) and was left to incubate for 1, 10, and 30 min. Each filter was placed in a Falcon tube with 10 mL of TSB and was sonicated for 5 min at 24° C. After that, each tube was stirred with a vortex for 1 min. Serial dilutions of each Falcon were performed for phage titration, and 100 μl of each phage dilution were brought into contact with 100 μl of the host strain at OD 600 nm=0.5. The infectious capacity of the phage was measured based on the double-layer method [Kropinski, A. M.; Mazzocco, A; Waddell, T. E.; Lingohr, E.; Johnson, R. P. Enumeration of bacteriophages by double agar overlay plaque assay. Methods Mol. Biol. 2009, 501, 69-76], where 4 ml of top agar (TSB+0.75% bacteriological agar, Scharlau) and 5 mM CaCl₂) were added to the mixture of phages and bacteria poured into TSA plates. The plates were incubated for 24 to 48 h in an oven at 25° C. The phage titer of each type of sample was calculated in PFU/mL and compared with the control, i.e., 50 μL of phages added to the bacterium without coming into contact with any filter and without being sonicated. The antiviral activity in log reductions of titers was determined at 1, 10 and 30 min of contact with the viral model. It was checked that the residual amounts of disinfectants in the titrated samples did not interfere with the titration process and that the sonication-vortex treatment did not affect the infectious capacity of the phage. Antiviral tests were performed three times on two different days (n=6) to ensure reproducibility.

1.8. Antiviral Tests with SARS-CoV-2

The SARS-CoV-2 strain used in this study (SARS-CoV-2/Hu/DP/Kng/19-027) was kindly provided by Dr. Tomohiko Takasaki and Dr. Jun-Ichi Sakuragi of the Public Health Prefectural Institute of Kanagawa. The virus was plaque purified and propagated in Vero cells. SARS-CoV-2 was stored at −80° C. A 50 μL volume of a virus suspension in phosphate-buffered saline (PBS) solution was added to each filter at a titer dose of 1.3*105 TCID50/filter and was then incubated for 1 min at room temperature. Then 1 ml of PBS was added to each filter, and it was then stirred with a vortex for 5 min. After that, each tube was stirred with a vortex for 5 min at room temperature.

The viral titers were determined by means of mean tissue culture infectious doses (TCID50) in a level 3 biosafety lab at the University of Kyoto. Briefly, TMPRSS2/Vero cells [Matsuyama, S.; Nao, N.; Shirato, K.; Kawase, M.; Saito, S.; Takayama, I.; Nagata, N.; Sekizuka, T.; Katoh, H.; Kato, F.; et al. Enhanced isolation of SARS-CoV-2 by TMPRSS2-expressing cells. Proc. Natl. Acad. Sci. USA 2020, 117, 7001-7003] (JCRB1818, JCRB Cell Bank), cultured with minimum essential medium (MEM, Sigma-Aldrich) supplemented with 5% fetal bovine serum (FBS), 1% penicillin/streptomycin, were seeded in 96-well plates (Thermo Fisher Scientific). The samples were subjected to serial dilution 10 times from 10⁻¹ to 10⁻⁸ in the culture medium. The dilutions were placed in the TMPRSS2/Vero cells in triplicate and incubated at 37° C. for 96 h. The cytopathic effect was evaluated under a microscope. TCID50/ml was calculated by means of the Reed-Muench method.

### 1.9. Antibacterial Tests

Antibacterial disk diffusion tests in agar were performed to analyze the antibacterial activity of the treated and untreated plastics [Marti, M; Frigols, B.; Serrano-Aroca, A. Antimicrobial Characterization of Advanced Materials for Bioengineering Applications. J. Vis. Exp. 2018, e57710.; Shao, W; Liu, H.; Liu, X.; Wang, S.; Wu, J.; Zhang, R.; Min, H.; Huang, M. Development of silver sulfadiazine loaded bacterial cellulose/sodium alginate composite films with enhanced antibacterial properties. Carbohidr. Polym. 2015, 132, 351-358.]. The methicillin-resistant bacterium Staphylococcus aureus, COL [Gill, S. R.; Fouts, D. E.; Archer, G. L.; Mongodin, E. F.; DeBoy, R. T.; Ravel, J.; Paulsen, I. T.; Kolonay, J. F.; Brinkac, L.; Beanan, M.; et al. Insights on evolution of virulence and resistance from the complete genome analysis of an early methicillin-resistant Staphylococcus aureus strain and a biofilm-producing methicillin-resistant Staphylococcus epidermidis strain. J. Bacteriol. 2005, 187, 2426 2438.], and methicillin-resistant Staphylococcus epidermidis, RP62A [Christensen, G. D.; Bisno, A. L.; Parisi, J. T.; McLaughlin, B.; Hester, M. G.; Luther, R. W. Nosocomial septicemia due to multiple antibiotic-resistant Staphylococcus epidermidis. Ann. Intern. Med. 1982, 96, 1-10.] were used at a concentration of about 1.5*10⁸ CFU/ml in tryptic soy broth, cultured in trypticase soy agar plates. The sterilized disks were placed on the bacterial lawn to incubate them aerobically at 37° C. for 24 h. The antibacterial activity of the assayed filter disks was expressed according to equation (1) [Marti, M.; Frigols, B.; Serrano-Aroca, Á. Characterization of Advanced Materials for Bioengineering Applications. J. Vis. Exp. 2018, e57710.]:

### 1.10. Statistical Analysis

The statistical analyses were performed by means of ANOVA followed by Tukey's test for post hoc analysis (*p>0.05, ***p>0.001) in GraphPad Prism 6 software (gGraphPad Software Inc., San Diego, Calif., USA).

2. Results

### 2.1. Coating Morphology

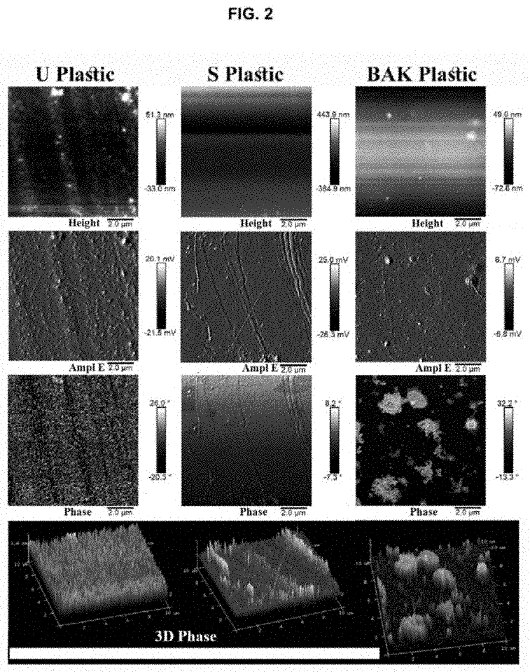

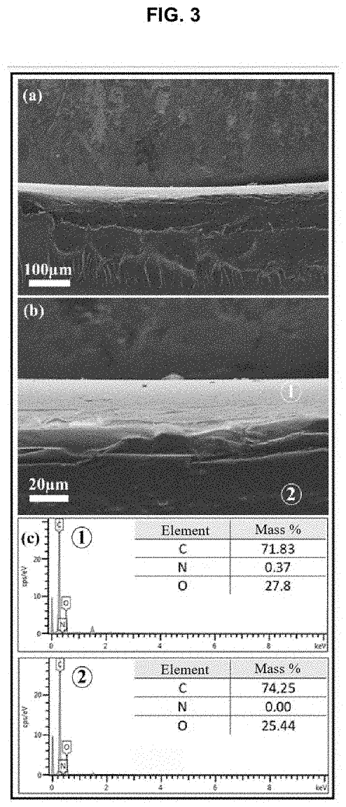

Atomic force microscopy, electron microscopy, and elemental analysis were performed to characterize the BAK microcoating formed on the PET plastic. FIG. 2 shows the AFM images of the treated and untreated PET plastic on a scanning area measuring 10 m×10 m. The images of the topography and the phase angle clearly indicate that a BAK coating is formed on the surface of the PET after the dip-coating treatment with the solvent containing BAK (FIG. 2). FIG. 2 shows that the untreated plastic (U Plastic) presents some impurities on its surface which disappear after immersing the disk in 70% ethanol for 30 minutes. Therefore, surface imperfections produced by the plastic manufacturing method can clearly be observed in the 2D phase image for S Plastic. However, BAK plastic AFM images clearly show that a BAK coating covering all the imperfections observed in the 2D phase image of the S Plastic sample was formed, according to the FESEM images shown in the following FIG. 3. This coating has slightly higher areas that are observed as white areas in the phase images.

The FESEM micrographs in FIG. 3 clearly show how a BAK salt (gray phase) microcoating is formed on the surface of the PET (darker phase) with a thickness of about 25 m, thereby confirming that the BAK compound adheres to the PET plastic. Furthermore, EDS analysis shows a 0.37% by weight nitrogen content in the BAK coating, that is consistent with the nitrogen atom present in the BAK compound and absent in the PET plastic. Therefore, EDS analysis in the PET matrix does not show this nitrogen content as was expected.

### 2.2. Opacity

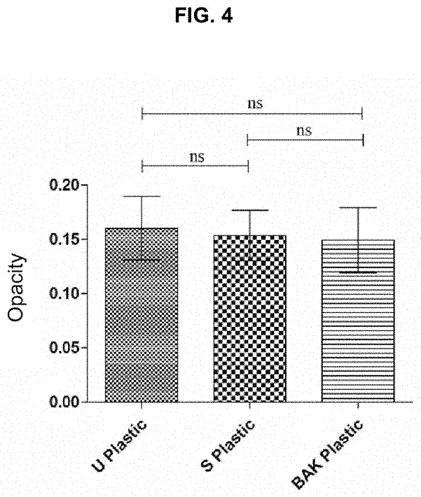

FIG. 4 shows how there are not statistically significant differences in transparency (or opacity) of the PET disks before and after treatments with solvent or treatment with BAK, which is fundamental for the final use of the transparent protection equipment (face protection shields, protective shields, helmets, protective glasses, protective counter, transparent space divider, etc.) is essential. For quantitative results, opacity (O), which is an established measurement of transparency, was calculated using equation (1) and is shown in FIG. 4.

### 2.3. Antibacterial Activity

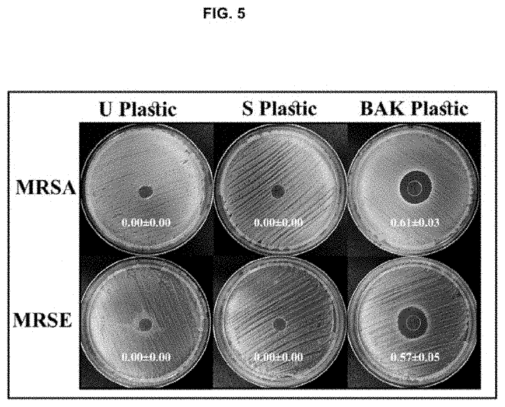

FIG. 5 shows the antibacterial results obtained from the untreated plastics (U plastic), the plastic treated with absolute ethanol/distilled water (70/30 v/v) referred to as S Plastic, and the plastic treated with 70% ethanol containing benzalkonium chloride (BAK Plastic) against multi-resistant bacteria MRSA and MRSE.

It can therefore be observed that plastics with the BAK biofunctional coating (BAK Plastic) showed powerful antibacterial activity against MRSA and MRSE with normalized antibacterial halos of 0.61±0.03 and 0.57±0.05, respectively.

### 2.4. Antiviral Activity

An RNA virus with an envelope was used as the biosafe viral model of the SARS-CoV-2 and other viruses with an envelope, such as the flu virus.

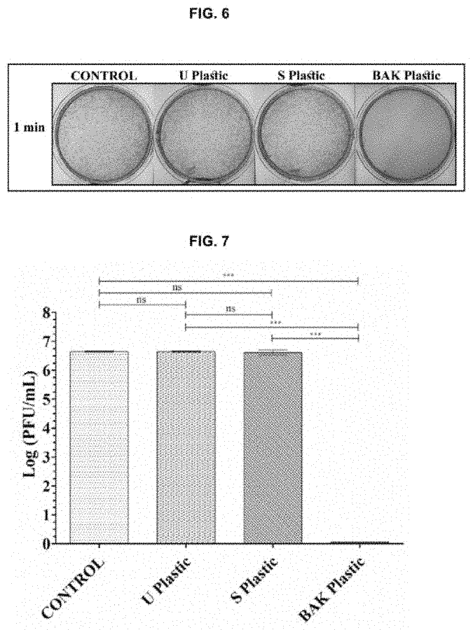

Phage phi6 is a double-stranded RNA virus segmented into three parts, a total of ˜ 13.5 kb long. Although this type of lytic bacteriophage belongs to group III in the Baltimore classification [Baltimore, D. Expression of animal virus genomes. Bacteriol. Rev. 1971, 35, 235-241], it was proposed in this case as a viral model of SARS-CoV-2, for biosafety reasons since it also has a lipid membrane around its nucleocapsid. Therefore, BAK plastic showed strong antiviral activity against this virus (100% viral inhibition, see FIGS. 3 and 4). The bacteria grew and no bald spots were observed after 1 minute of contact of the biosafe viral model of SARS-CoV-2 with the surface of the BAK plastic. Furthermore, the untreated plastic (U Plastic) and the plastic treated with the solvent without benzalkonium chloride (S Plastic) showed results similar to the control without antiviral activity (see FIGS. 6 and 7).

Phage titers of each type of sample were calculated and compared with the control (see FIG. 7 and Table 1 below).

TABLE 1
Phi6 phage titers a 1 minute of contact: control, untreated
plastic (U Plastic), plastic treated with the solvent but
without benzalkonium chloride (S Plastic), and plastic with
biofunctional benzalkonium chloride coating (BAK Plastic)

| | Phage phi6 at 1 min of |
|---|---|
| Sample | contact (PFU/mL) |
| Control | 4.36 × 10⁶ ± 2.92 × 10⁵ |
| U Plastic | 4.38 × 10⁶ ± 1.98 × 10⁵ |
| S Plastic | 4.23 × 10⁶ ± 1.36 × 10⁶ |
| BAK Plastic | 0.00 ± 0.00 |

FIG. 7 and Table 1 show that the titers obtained upon bringing the phages into contact with the untreated plastic (U Plastic) or the plastic treated with the solvent without benzalkonium chloride (U Plastic) are similar to the control. However, the plastic with the biofunctional benzalkonium chloride coating (BAK Plastic) showed strong phage inactivation.

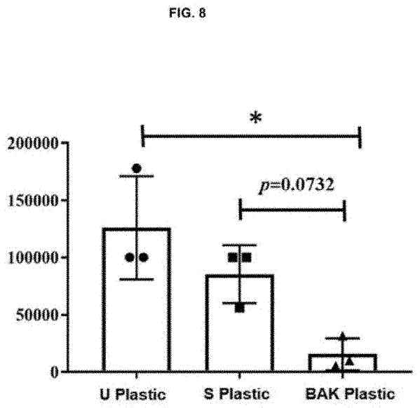

The results obtained with SARS-Co-2 after 1 min of contact with the untreated plastic (U Plastic) or the plastic treated with the solvent without benzalkonium chloride (U Plastic) and the plastic with the biofunctional benzalkonium chloride coating (BAK Plastic) are shown in FIG. 8 and Table 2.

TABLE 2
SARS-CoV-2 virus titers at 1 minute of contact: untreated
plastic (U Plastic), plastic treated with the solvent but
without benzalkonium chloride (S Plastic), and plastic with
biofunctional benzalkonium chloride coating (BAK Plastic)

| | SARS-CoV-2 at 1 min |
|---|---|
| Sample | (PFU/mL) |
| U Plastic | 1.26 × 10⁵ ± 4.50 × 10⁴ |
| S Plastic | 8.54 × 10⁴ ± 2.53 × 10⁴ |
| BAK Plastic | 1.57 × 10⁴ ± 1.39 × 10⁴ |

These results clearly demonstrate that the plastic with BAK biofunctional coating (BAK Plastic) is very effective against SARS-CoV-2, inactivating more than 99% of the virus in 1 minute of contact. These results confirm the antiviral activity obtained by means of the Phi6 biosafe viral model used in this study (see FIGS. 6 and 7).

### LITERATURE REFERENCES

1. WHO Director-General's opening remarks at the mean briefing on COVID-19-11 Mar. 2020 Available online: https://www.who.int/dg/speeches/detail/whodirector-general-s-opening-remarks-at-the-mean-briefing-on-covid-19—-11-march-2020.
2. WHO Coronavirus disease (COVID-19) Pandemic Available online: https://www.who.int/emergencies/diseases/novel-coronavirus-2019.
3. Liu, Y.; Gayle, A. A.; Wilder-Smith, A.; Rocklov, J. The reproductive number of COVID-19 is higher compared to SARS coronavirus. J. Travel Med. 2020.
4. Lu, R.; Zhao, X.; Li, J.; Niu, P.; Yang, B.; Wu, H.; Wang, W.; Song, H.; Huang, B.; Zhu, N.; et al. Genomic characterisation and epidemiology of 2019 novel coronavirus: implications for virus origins and receptor binding. Lancet 2020, 395, 565-574.
5. Jiang, S.; Du, L.; Shi, Z. An emerging coronavirus causing pneumonia outbreak in Wuhan, China: calling for developing therapeutic and prophylactic strategies. Emerg. Microbes Infect. 2020, 9, 275-277.
6. Ren, L.-L.; Wang, Y.-M.; Wu, Z.-Q.; Xiang, Z.-C.; Guo, L.; Xu, T.; Jiang, Y.-Z.; Xiong, Y.; Li, Y.-J.; Li, X.-W.; et al. Identification of a novel coronavirus causing severe pneumonia in human. Chin. Med. J. (Engl). 2020, 1.
7. Lai, C. C.; Shih, T. P.; Ko, W. C.; Tang, H. J.; Hsueh, P. R. Severe acute respiratory syndrome coronavirus 2 (SARS-CoV-2) and coronavirus disease-2019 (COVID-19): The epidemic and the challenges. Int. J. Antimicrob. Agents 2020.
8. van Doremalen, N.; Bushmaker, T.; Morris, D. H.; Holbrook, M. G.; Gamble, A.; Williamson, B. N.; Tamin, A.; Harcourt, J. L.; Thornburg, N. J.; Gerber, S. I.; et al. Aerosol and Surface Stability of SARS-CoV-2 as Compared with SARS-CoV-1. N. Engl. J. Med. 2020, NEJMc2004973.
9. Bourouiba, L. Turbulent Gas Clouds and Respiratory Pathogen Emissions Potential Implications for Reducing Transmission of COVID-19. JAMA 2020.
10. Vellingiri, B.; Jayaramayya, K.; Iyer, M.; Narayanasamy, A.; Govindasamy, V.; Giridharan, B.; Ganesan, S.; Venugopal, A.; Venkatesan, D.; Ganesan, H.; et al. COVID-19: A promising cure for the global panic. Sci. Total Environ. 2020, 725, 138277.
11. American Lung Association Learn About Pneumonia I American Lung Association.
12. Singhal, T. A Review of Coronavirus Disease-2019 (COVID-19). Indian J. Pediatr. 2020, 87, 281-286.
13. Bai, Y.; Yao, L.; Wei, T.; Tian, F.; Jin, D. Y.; Chen, L.; Wang, M. Presumed Asymptomatic Carrier Transmission of COVID-19. JAMA—J. Am. Med. Assoc. 2020.

1. A facial protection element with a biocidal effect comprising a body with at least one surface made of transparent and impermeable plastic material or glass, characterized in that said surface comprises a coating layer of a biocidal agent.

2. The facial protection element according to claim 1, characterized in that the biocidal agent coating layer comprises at least one compound selected from: triclosan, citric acid, acetic acid, sodium 2-biphenylate, sodium hypochlorite, salicylic acid, alkyldimethyl benzyl ammonium chloride, hydrogen peroxide, sodium dichloroisocyanurate, didecyldimethylammonium chloride, C12-16 alkyldimethyl benzyl ammonium chloride, sodium dichloroisocyanurate, sodium dichloroisocyanurate dihydrate, propan-1-ol, glutaraldehyde, peracetic acid, isopropyl alcohol, ethanol, benzyl-C12-C16-alkyldimethyl ammonium chloride, pentapotassium bis(peroxymonosulfate) bis(sulfate), C12-18 saccharinate, orthophenylphenol, orthophenylphenol, chlorine dioxide, pentapotassium bis(peroxymonosulfate) bis(sulfate), didecyldimethylammonium chloride, N-dichlorofluoromethylthio-N′,N′-dimethyl-N-phenyl-sulfamide (dichlofluanid), pyridine-2-thiol-1-oxide, sodium salt (sodium pyrithione), sulfur dioxide, sodium bromide, ammonium sulfate, silver, silver chloride, ammonium bromide, potassium 2-biphenylate, bromine chloride, sodium p-Chloro-m-cresolate, mixture of cis- and trans-p-menthane-3,8-diol (citriodiol), tetrakis(hydroxymethyl)phosphonium sulfate (1:2) (THPS), didecyldimethylammonium chloride (DDAC (C₈₋₁₀)), 6-(phthalimido)peroxyhexanoic acid (PAP), tetrachlorodecaoxide complex (TCDO), active chlorine: obtained by the reaction of hypochlorous acid and sodium hypochlorite produced in situ, silver and zinc zeolite, silver and copper zeolite, esfenvalerate/(S)-α-cyano(3-phenoxybenzyl) (S)-2-(4-chlorophenyl)-3-methylbutyrate (esfenvalerate), boric acid, borax, copper nanoparticles, gold, silver, graphene, graphene oxide, fullerene, carbon dots, graphite, reduced graphene oxide, reduced graphene, simple or multi-walled carbon nanotubes, carbon nanofibers, fullerene, alkylamine- or ammonia-functionalized graphene oxide, boron doped graphene, nitrogen doped graphene, phosphorus doped graphene, sulfur doped graphene, boron and nitrogen doped graphene, phosphorus and nitrogen doped graphene, sulfur and nitrogen doped graphene and sulfonated reduced graphene oxide, graphene/TiO₂, graphene/Fe₃O₄, graphene/Mn₃O₄, graphene/Pd, graphene/Pt, graphene/PtCo, graphene/PtPd, reduced graphene/TiO₂, reduced graphene/Fe₃O₄, reduced graphene/Mn₃O₄, reduced graphene/Pd, reduced graphene/Pt, reduced graphene/PtCo and reduced graphene/PtPd, geraniol, thymol, citrodiol, sanicitrex, condensed tannins, procyanidin or proanthocyanidins A, B, C and D (A1, A2, A3, A4, B1, B2, B3, C1, C2, C3, D1, D2, D3, etc.), grapeseed extract, cranberry, blueberry, and blackberry extract, cocoa extract, flavanols, flavonoids, afzelechin, cinnamon extract, green and black tea extract, catechin, epicatechin gallate, epigallocatechin, epigallocatechin gallate, proanthocyanidins, theaflavins, thearubigins, polyphenols, citronella and compounds of quaternary ammonium and derivatives thereof, such as: benzethonium chloride, methylbenzethonium chloride, cetalkonium chloride, cetylpyridinium chloride, cetrimonium, cetrimide, tetraethylammonium bromide, didecyldimethylammonium chloride, domiphen bromide, benzalkonium chloride.

3. The facial protection element according to claim 2, characterized in that the biocidal agent comprises at least one quaternary ammonium compound selected from: benzethonium chloride, methylbenzethonium chloride, cetalkonium chloride, cetylpyridinium chloride, cetrimonium, cetrimide, tetraethylammonium bromide, didecyldimethylammonium chloride, domiphen bromide, and benzalkonium chloride.

4. The facial protection element according to claim 1, characterized in that the thickness of the coating is between 0.001 to 100 μm.

5. The facial protection element according to claim 4, characterized in that the thickness of the coating is 25 μm.

6. The facial protection element according to claim 1, characterized in that the plastic material is a thermoplastic material, made from synthetic or natural and/or biodegradable plastic materials as well as mixtures thereof.

7. The facial protection element according to claim 6, characterized in that the plastic material is a thermoplastic material synthetic selected from: polyethylene terephthalate (PET), polyvinyl chloride (PVC), polypropylene (PP), high or low density polyethylene (PE), polycarbonate (PC), polymethyl-methacrylate (PMMA), polystyrene (PS), polyhydroxyethyl acrylate (PHEA), polyhydroxyethyl methacrylate (PHEMA), polyamide or nylon (PA), polybutylene (PB) and Teflon (or polytetrafluoroethylene, PTFE), polypyrrole (PPy), polyaniline, polythiophene, poly(3,4-ethylenedioxythiophene), poly(3,4-ethylenedioxythiophene, poly(3,4-ethylenedioxythiophene)-poly(styrene sulfonate), polythiophene-vinylidene), poly(2,5-thiethylene-vinylidene), poly(3-alkylthiophene), poly(p-phenylene), poly-p-phenylene-sulfide, poly(p-phenylenevinylene), poly(p-phenylene-terephthalamide), poly(3-octylthiophene-3-methylthiophene), and poly(p-phenylene-terephthalamide), poly(vinyl alcohol) (PVA), as well as mixtures thereof.

8. The facial protection element according to claim 6, characterized in that the natural and biodegradable material is selected from chitosan, hyaluronic acid, carrageenan, starch, acacia gum, xanthan gum, pectins, proteins, chitin, pullulan, non-crosslinked alginate, calcium alginate, zinc alginate, strontium alginate, and other alginate hydrogels crosslinked with other divalent cations, poly(3-hydroxybutyrate-co-3-hydroxyvalerate) (PHBV), poly(3-hydroxypropionate), poly(3-hydroxybutyrate), poly(3-hydroxyvalerate), poly(3-hydroxyhexanoate), poly(3-hydroxyoctanoate), poly(3-hydroxyoctadecanoate), poly(4-hydroxybutyrate), poly(4-hydroxyvalerate), poly(5-hydroxyvalerate)gelatin, and/or collagen, as well as mixtures thereof.

9. The facial protection element according to claim 1, characterized in that the biocidal effect comprises inactivation of human coronavirus (HCoV), hepatitis B virus (HVB), hepatitis C virus (HCV), hepatitis D virus (HDV), dengue virus (DENV), Japanese encephalitis virus (JEV), yellow fever virus, Western Nile virus (WNV), Venezuelan equine encephalitis virus (VEEV), Eastern equine encephalitis virus (EEEV), Western equine encephalitis virus (WEEV), tick-borne encephalitis virus (TBEV), Rift Valley fever virus (RVFV), herpes simplex virus type 1, herpes simplex virus type 2, human herpesvirus 6 (HHV-6), human herpesvirus 7 (HHV-7), human T-lymphotropic virus (HTLV), Epstein Barr virus (EBV), human cytomegalovirus (HCMV), Lassa virus (LASV), lymphocytic choriomeningitis virus (LCMV), Nipah virus, influenza A virus, influenza B virus, influenza C virus, Hantaan virus (HTNV), Junin virus, rabies virus, Ebola virus, Marburg virus (MARV), Zika virus (ZIKV), severe acute respiratory syndrome coronavirus (SARS-CoV), severe acute respiratory syndrome coronavirus type 2 (SARS-CoV-2), Middle East respiratory syndrome coronavirus (MERS-CoV), human coronavirus 229E (HCoV-229E), human coronavirus OC43 (HCoV-OC43), human coronavirus NL63 (HCoV-NL63), human coronavirus HKU1 (HCoV-HKU1), human immunodeficiency virus (HIV), varicella-zoster virus (VZV), measles virus, mumps virus (MuV), human respiratory syncytial virus (RSV), rubella virus (RuV), as well as multidrug-resistant Gram-positive bacteria, such as Streptococcus pneumoniae, Staphylococcus aureus, Staphylococcus epidermidis, Streptococcus pyogenes, Streptococcus agalactiae, Bacillus anthracis, Enterococcus faecalis, and Enterococcus faecium, after contact with the surface made of plastic material comprising the coating.

10. The facial protection element according to claim 1, characterized in that it is presented in the form of a face shield, helmet, glasses, mask, space partitioning shield of the type intended for a counter or vehicles.
